(19) United States
(12) Patent Application Publication
(10) Pub. No.: US 2026/0211671 A1
(43) Pub. Date: Jul. 23, 2026

(54) System and Method for Schema-Driven AI Agent Generation and Lifecycle Governance

(71) Applicant: Marc Lane, Indianapolis, IN (US)

(72) Inventor: Marc Lane, Indianapolis, IN (US)

(73) Assignee: Change Directories LLC, Indianapolis, IN (US)

(21) Appl. No.: 19/362,686

(22) Filed: Oct. 20, 2025

(51) Int. Cl. G06F 8/71; G06F 11/30; G06F 21/53

(52) U.S. Cl. CPC G06F 8/71; G06F 11/302; G06F 21/53; G06F 2201/865

(57) ABSTRACT

A system and method for governing the lifecycle of artificial-intelligence agents through schema-driven compliance and governed feedback control. The system, termed Schema-Driven AI Agent Generation and Lifecycle Governance (ALG Layer), comprises an Archetype Registry of agent templates, a Context Compiler for mapping tasks to archetypes, an Agent Forge for instantiating new agents with embedded governance metadata, a Lifecycle Manager for monitoring and evolving agents, and a Compliance Interface linked to policy rules. Each instantiated agent inherits a unique lineage identifier, a compliance signature, and a telemetry endpoint for oversight, and communicates through typed telemetry objects compatible with governed reasoning systems. The system further incorporates a Loop Governor that detects non-convergent lifecycle adaptation cycles and enforces policy-gate validation at pre-compose, pre-execute, in-loop, and pre-emit stages. These features ensure that all generated agents remain compliant, stable, and traceable throughout their lifecycle, enabling adaptive multi-agent ecosystems under explicit governance control.

### CROSS-REFERENCE TO RELATED APPLICATIONS

This application is related to U.S. patent application Ser. No. 19/362,621, entitled “Dual-Hemisphere Cognitive Control Architecture for Governed AI Reasoning.” The entire disclosure of that application is incorporated herein by reference.

### STATEMENT REGARDING FEDERALLY SPONSORED RESEARCH OR DEVELOPMENT

No federally sponsored research or development was involved in the conception or reduction to practice of the present invention.

### FIELD OF THE INVENTION

The present invention relates to multi-agent artificial-intelligence (AI) systems and, more particularly, to systems and methods for dynamically generating, managing, and retiring AI agents with embedded compliance and governance features.

### BACKGROUND OF THE INVENTION

### Description of Related Art

Modern AI deployments often consist of multiple specialized agents or modules that collaborate to perform complex tasks. Representative systems have explored aspects of multi-agent orchestration but exhibit limitations in adaptability and governance.

Static Orchestration Pipelines. Representative systems such as LangChain (2023) enable chaining of large-language-model (LLM) calls and tools in predefined sequences for task automation. These pipelines require developers to manually specify the chain of actions and cannot automatically create new agent capabilities at runtime. When novel tasks arise, workflows must be manually updated. Such frameworks also lack integrated governance: intermediate steps are not tracked beyond basic logs, and compliance enforcement depends on ad-hoc developer checks.

Multi-Agent Collaboration Frameworks. Representative environments such as CrewAI (2024) support multiple AI agents with distinct roles communicating to solve problems. Role assignments (for example, “Solver” and “Critic”) are fixed at design time. These frameworks do not support dynamic introduction of new agent types during execution and lack centralized lifecycle management. Agent retirement or role merging requires manual intervention. Governance and compliance features are generally absent, and agent interactions are not automatically recorded for auditability.

Automated Agent Task Decomposition. Experimental systems such as AutoGPT (2023) and AutoGen (2024) explored autonomous spawning of sub-agents to achieve high-level goals. While these approaches demonstrated potential for self-organization, they lacked schema-based control or governance mechanisms. Without standardized templates or oversight processes, spawned agents could loop endlessly, proliferate unpredictably, or perform unauthorized actions, leading to inconsistent behavior and non-compliant outcomes.

Tool-Integration Frameworks. Representative frameworks such as Microsoft Semantic Kernel (2023) allow an AI agent to invoke external functions or skills dynamically through planners. These systems focus on connecting a single agent to multiple tools rather than creating new agents. Available functions are predefined; no mechanism exists to generate or retire agents dynamically. Governance is limited to developer-implemented checks rather than native policy enforcement or provenance tracking.

Cognitive Architectures. Classical architectures such as Soar (Laird et al., 1987) and ACT-R (Anderson et al., 1998) organize cognition into modules (goal selection, memory retrieval, rule-based learning) within a single agent. They do not support dynamic multi-agent scenarios or the creation of independent agents. These systems predate modern machine-learning pipelines and lack mechanisms for compliance auditing or policy alignment.

AI Alignment and Governance Techniques. Representative alignment methods such as Anthropic's Constitutional AI (2023) constrain an individual model's outputs using fixed principles. While effective for single-agent output moderation, these techniques do not address multi-agent orchestration or lifecycle management. They regulate responses within one model rather than governing the creation, operation, or retirement of distinct agents.

In summary, existing systems do not enable dynamic generation and governance of multiple AI agents. Current frameworks either remain static—unable to modify agent roles at runtime—or become uncontrolled when attempting autonomy, lacking templates, guardrails, or lifecycle oversight. None provides a schema-driven approach for agent “genetics,” where new agents can inherit policy constraints, be tracked for lineage, and be retired or merged automatically.

For example, Siebel et al., U.S. Pat. No. 12,111,859 (issued Oct. 31, 2024) describes an AI orchestration platform that manages multiple models for enterprise queries but assumes a fixed library of models. It emphasizes data sourcing and answer traceability rather than dynamic alteration of the model set. It does not teach generation of new model instances or agent processes at runtime. Similarly, none of the representative frameworks above includes a dedicated mechanism ensuring that newly introduced AI components automatically conform to organizational policies or are logged for accountability.

Accordingly, there is a need for an improved system and method that allow an AI environment to generate, adapt, and retire specialized agents dynamically as tasks and conditions evolve—while embedding compliance tagging, telemetry, and full lifecycle traceability.

The present invention addresses these needs through a schema-driven agent-lifecycle management architecture (“ALG Layer”) that provides adaptive generation and governed orchestration of AI agents.

### SUMMARY OF THE INVENTION

The present invention provides a schema-driven system for artificial-intelligence (AI) agent generation and lifecycle governance, referred to as ALG Layer. The invention manages the creation, adaptation, and retirement of AI agents in a governed, auditable manner. Any agent introduced or modified at runtime adheres to predetermined compliance rules and remains traceable through a unique lineage identifier.

In one embodiment, the invention comprises a modular, cognitive agent-management framework including the following representative components:
(a) Archetype Registry. A repository that stores templates (archetypes) defining agent types. Each archetype serves as a blueprint describing the agent's function, capabilities, compliance requirements, and inherited policy constraints. Archetypes may be version-controlled and updated as organizational knowledge or rules evolve.
(b) Context Compiler. A reasoning component that analyzes incoming tasks or environmental changes to determine the required agent or skill type. It maps task requirements to one or more archetypes in the registry. For example, when a new task involves processing legal documents, the Context Compiler may select a “Legal Document Analyzer” archetype. If no suitable archetype exists, the system can flag the need for a new archetype entry, optionally with human oversight.
(c) Agent Forge. A generative module that instantiates concrete agent instances from selected archetypes. Upon receiving an archetype and task context, the Agent Forge allocates necessary resources, initializes agent state, and embeds governance metadata, including: (i) a Lineage ID linking the agent to its archetype and any parent entity; (ii) a Compliance Signature specifying the policies and permissions applicable to that agent, optionally with cryptographic attestation; and (iii) a Telemetry Endpoint connecting the agent to system monitoring channels for real-time oversight.
(d) Lifecycle Manager. A supervisory module that monitors active agents, evaluating telemetry and performance against policy and objectives. The Lifecycle Manager governs adaptation and evolution, including triggering retraining or parameter tuning for underperforming agents, initiating merging or division of overlapping agents for efficiency, and retiring agents that are obsolete or superseded. Policy-driven triggers may specify conditions such as “merge duplicate analysis agents” or “replace agents below accuracy thresholds.”
(e) Compliance Interface. An integration layer connecting the ALG Layer to a broader governance framework or policy engine. It performs compliance checks and audit logging during agent creation, adaptation, and retirement, and mediates agent requests requiring higher-level approval. All significant lifecycle events are recorded through this interface into an audit ledger or compliance repository.

Algorithmic Implementation. In certain embodiments, the functions of the Archetype Registry, Context Compiler, Agent Forge, Lifecycle Manager, Compliance Interface, and Loop Governor are implemented as executable algorithms operating on digital data structures. These algorithms perform computable operations including vector parsing, weighted scoring, condition evaluation, rule enforcement, and convergence monitoring as described in the detailed embodiments. Each algorithm produces measurable transformations of data stored in computer memory, thereby improving the operation of the computing system itself by providing automated compliance enforcement, adaptive orchestration, and stability control that were previously performed manually or without traceability.

Together, these components enable controlled generativity of AI agents. The system autonomously generates, modifies, and retires agents as operational contexts evolve—without requiring developers to rewrite orchestration logic—while continuously enforcing compliance and traceability.

In certain embodiments, the ALG Layer operates in conjunction with a governed reasoning system that provides bidirectional telemetry and compliance feedback. Agent telemetry endpoints conform to a standardized object schema including confidence values, reasoning-class identifiers, constraint codes, and provenance hashes. This compatibility enables continuous synchronization between the lifecycle governance layer and any external cognitive controller, ensuring that both reasoning and agent-generation cycles are jointly monitored under a unified governance protocol.

Operationally, the ALG Layer functions as follows: (1) The system observes current task load and context. (2) The Context Compiler determines whether new or modified agents are needed. (3) The Archetype Registry supplies appropriate blueprints. (4) The Agent Forge instantiates new agents with embedded lineage and compliance data. (5) Agents operate under a higher-level orchestrator to perform specialized tasks. (6) The Lifecycle Manager supervises performance and triggers adaptation, merging, or retirement events. (7) The Compliance Interface ensures that all lifecycle transitions conform to governance rules and are logged.

The invention thereby provides a dynamic, governed agent-generation and custody layer within AI systems. Unlike prior frameworks that rely on static agent definitions or unregulated self-organization, ALG Layer formalizes agent generation, evolution, and retirement as first-class, auditable processes—analogous to continuous-integration pipelines in software engineering but intrinsic to AI orchestration.

Advantages. The system provides: ⋅Adaptability: New agents can be generated on demand for emerging tasks or contexts. ⋅Scalability: Agents can be split, merged, or retired automatically to balance workload. ⋅Governance and Trust: Every agent is created with a unique identity and compliance profile, supporting verifiable oversight in regulated domains. ⋅Maintainability: Updated archetypes enable seamless replacement of outdated agents, reducing technical debt. ⋅Auditability: Comprehensive lineage tracking ensures every decision or action can be traced to the responsible agent and archetype.

In summary, ALG Layer transforms a static multi-agent environment into a self-governing, schema-driven ecosystem, allowing adaptive intelligence while preserving organizational control and accountability.

### BRIEF DESCRIPTION OF THE DRAWINGS

The accompanying figures illustrate exemplary embodiments of the invention and form part of the present specification. The drawings are provided to facilitate understanding of the invention's principles and operation and are not to be construed as limiting the scope of the invention.

FIG. 1 is a block diagram illustrating the architecture of the ALG Layer system, showing the Archetype Registry, Context Compiler, Agent Forge, Lifecycle Manager, and Compliance Interface, along with their interactions and connections to an active Agent Pool and a Policy Store.

FIG. 2 is a flowchart depicting an agent generation and adaptation process according to one embodiment of the invention, including steps for task analysis, archetype selection, agent instantiation with compliance embedding, deployment, monitoring, and lifecycle adaptation or retirement.

FIG. 3 is a schematic diagram of an example computing environment that can implement the ALG Layer, illustrating how the components may be deployed across computing nodes, how agents interface with a telemetry system, and how the Compliance Interface interacts with an enterprise policy database and audit log.

FIG. 4 is a block diagram illustrating the structure of the telemetry object schema used by agents and supervisory modules, showing fields such as Confidence Value, Reasoning-Class Identifier, Constraint Code, and Provenance Hash, along with connections to the Compliance Interface and Policy Store.

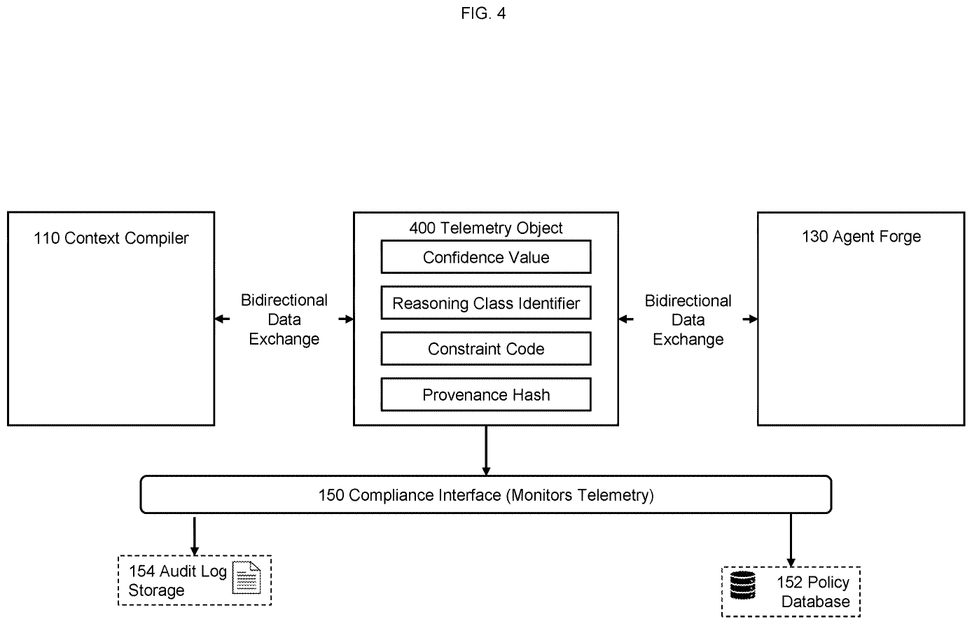

FIG. 5 is a sequence diagram depicting the four policy-gate stages—Pre-Compose, Pre-Execute, In-Loop, and Pre-Emit—demonstrating how the Compliance Interface evaluates and logs policy enforcement during agent generation and adaptation cycles.

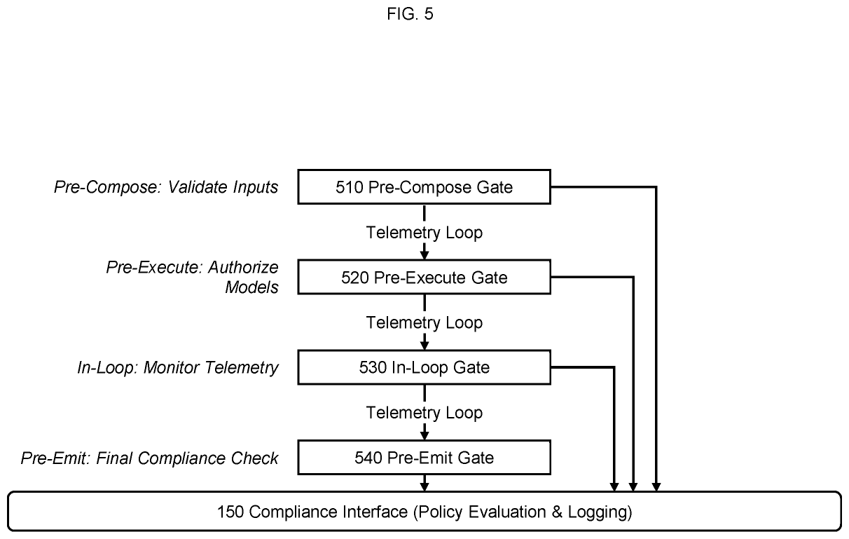

### DETAILED DESCRIPTION OF THE INVENTION

The following detailed description sets forth various embodiments of the ALG Layer architecture. These embodiments are intended to exemplify the invention and to enable one skilled in the art to make and use it. It is to be understood that modifications may be made without departing from the scope of the invention as defined by the appended claims.

### System Architecture

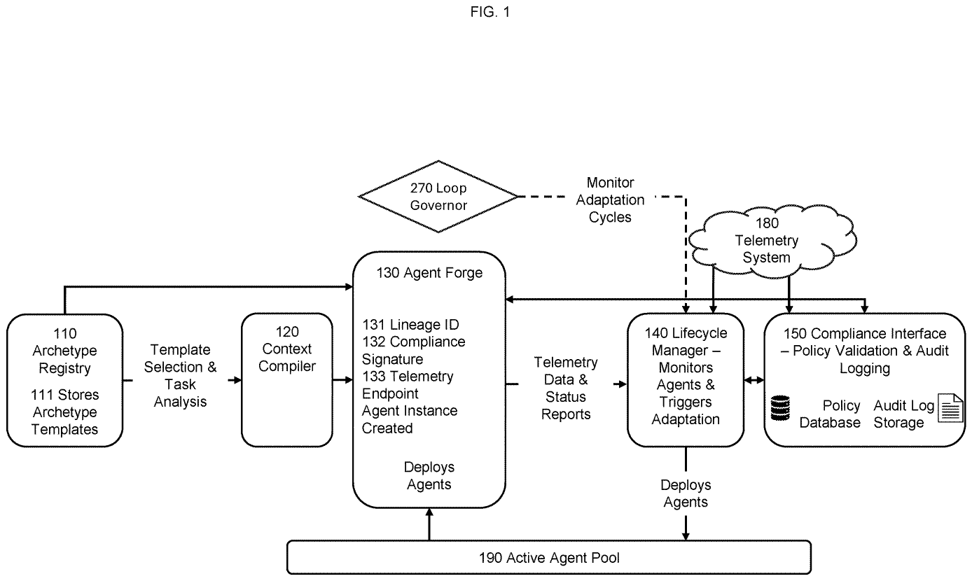

Referring to FIG. 1, the ALG Layer system architecture 100 is shown. The system operates as part of a larger AI platform (for example, EnvokeOS) and manages an active pool of AI agents 190. The core components are as follows.

Archetype Registry 110. A data repository that stores archetypes (templates) for AI agents. Each archetype entry 111 defines: (a) Agent Role and Capabilities, such as a “Data Summarizer Agent” configured to retrieve and synthesize information, or a “Translation Agent” for multilingual conversion; (b) Schema of Operation, including input-output specifications, required tools or models, and workflow logic; (c) Compliance Constraints, such as data-access permissions, regulatory tags, or policy restrictions (e.g., a medical AI archetype may carry a HIPAA-compliance flag); and (d) Version Information, allowing multiple versions to coexist while indicating which is current. The Archetype Registry 110 may be implemented as a relational database, graph store, or knowledge base. In certain embodiments, archetypes are expressed in a schema language (e.g., JSON or YAML) to permit automated ingestion and validation.

[Context Compiler 120. A reasoning module that receives descriptions of tasks, objectives, or changes in system context and determines which agents are needed. Inputs may include: (a) new user requests or goals; (b) system analyses (e.g., detection of unhandled data types); or (c) performance analytics (e.g., increasing response latency). The Context Compiler 120 generates a deployment plan specifying which archetypes should be instantiated, which agents should be re-configured or retired, and whether new archetypes are required. Internally, it may employ rule-based logic or machine-learning models for intent recognition and capability mapping. It also consults the Compliance Interface 150 to ensure that any proposed agent creation conforms to policy (e.g., restrictions on data scope or external API access). The following subsections illustrate exemplary algorithmic processes that may be executed by the respective system components to perform the functions described above.

Context Compiler Algorithm. In one embodiment, the Context Compiler 120 executes an adaptive selection algorithm comprising the following steps: (1) Parse the incoming task or system event into a structured feature vector F={goal, domain, input_type, constraints, urgency}. (2) Query the Archetype Registry 110 using F as search criteria to retrieve candidate archetypes A={a₁, a₂, . . . , aₙ} whose capability tags overlap with F.domain and F.goal. (3) For each candidate aᵢ, compute a relevance score R(aᵢ, F)=Σwᵢ×match(fᵢ, aᵢ.featureᵢ), where wᵢ are dynamically weighted coefficients representing organizational priorities or compliance constraints. (4) Discard any aᵢ for which the Compliance Interface 150 reports policy incompatibility. (5) Select the highest-scoring archetype and generate a deployment plan P={selected_archetype, initialization_parameters, resource_estimate, compliance_signature_template}. (6) Return P to the Agent Forge 130 for instantiation.

Agent Forge 130. A generative component responsible for instantiating new agents from archetypes. The Agent Forge interfaces with the Archetype Registry 110 and the Compliance Interface 150 to produce a runnable agent instance. Upon instantiation, the Agent Forge: (1) allocates resources and loads any machine-learning models specified by the archetype; (2) assigns a Lineage ID 131 encoding the agent's origin and parental relationships; (3) issues a Compliance Signature 132 through the Compliance Interface 150, attesting to authorized functions and constraints; and (4) registers a Telemetry Endpoint 133 with the observability system 180 for continuous status reporting and command reception. Once activation is complete, the agent is added to the Active Agent Pool 190 for operational use.

Agent Forge Algorithm. The Agent Forge 130 executes an instantiation and registration algorithm to create governed agent instances: (1) Receive deployment plan P from the Context Compiler 120. (2) Allocate computational resources according to P.resource_estimate. (3) Retrieve the selected archetype definition from the Archetype Registry 110. (4) Instantiate a new agent process and assign a unique Lineage ID 131=hash(archetype_ID∥timestamp∥ random_seed). (5) Request a Compliance Signature 132 from the Compliance Interface 150 by submitting the archetype ID and operational context. (6) Initialize telemetry instrumentation and register the agent's Telemetry Endpoint 133 with the observability subsystem 180. (7) Activate the agent, record creation metadata {Lineage ID, Archetype ID, Compliance Signature, Timestamp} in the Audit Log 154, and add the agent to the Active Agent Pool 190.

Lifecycle Manager 140. A supervisory module that optimizes and maintains the agent population. It evaluates telemetry to detect trigger conditions such as under-performance, new context emergence, peer conflict, or compliance updates. In response, it may: (a) retune or retrain an agent; (b) spawn a successor agent from an improved archetype; (c) merge redundant agents; or (d) retire obsolete agents. All actions are vetted through the Compliance Interface 150 before execution to ensure policy conformance and audit logging.

Lifecycle Manager Algorithm. The Lifecycle Manager 140 performs continuous evaluation and adaptation using the following algorithm: While system_state=RUNNING: Acquire telemetry vector M={performance_metrics, compliance_flags, context_signals} from all active agents. For each agent aᵢ in Active Agent Pool 190: If M.aᵢ.performance<threshold_underperformance→invoke Adjust(aᵢ). Else if new_context_signal_detected(aᵢ)=TRUE→Spawn(successor(aᵢ)). Else if conflict_score(aᵢ, aⱼ)>τ→Merge(aᵢ, aⱼ). Else if policy_update_flag(aᵢ)=TRUE→Reconfigure(aᵢ). Send all proposed lifecycle actions to the Compliance Interface 150 for validation. If approved, execute validated actions and log results in the Audit Log 154. Sleep Δt and repeat. EndWhile.

Compliance Interface 150. This module links the ALG Layer to a Policy Store 152 and an Audit Log 154. It determines applicable governance rules for each agent, issues the Compliance Signature, monitors runtime actions for violations, and records all lifecycle events (creation, adaptation, retirement). When a rule requires human approval, the Compliance Interface can pause execution until authorization is granted through a governed workflow.

Compliance Interface Algorithm. The Compliance Interface 150 applies a rule-evaluation algorithm to enforce policy constraints: For each event e emitted by any agent: Retrieve applicable rule set R from the Policy Store 152 where R.scope⊇e.context. For each rule r∈R: Evaluate condition(r) against e.attributes. If condition(r)=TRUE: Execute r.action∈{block, halt, notify, quarantine}. Append an entry to Audit Log 154 containing {agent_ID, rule_ID, action, timestamp}. If r.action=halt→send halt command to Lifecycle Manager 140. Break. If no rule triggered, forward e to downstream subsystems. EndFor.

Loop Governor 270. In certain embodiments, a Loop Governor 270 monitors the adaptation and retirement cycles executed by the Lifecycle Manager 140. The Loop Governor detects excessive or non-convergent adaptation activity and suspends further lifecycle changes until the system is reviewed or stabilized. This safeguard prevents recursive reconfiguration loops within the agent ecosystem and maintains operational equilibrium in the governed environment.

Telemetry Integration. Each agent's telemetry endpoint communicates using structured telemetry objects of the form {confidence_value, reasoning_class_identifier, constraint_code, provenance_hash}. These objects are exchanged between the Lifecycle Manager and the Compliance Interface to enable fine-grained analysis of performance, compliance, and convergence. The telemetry schema is compatible with that described in the Dual-Hemisphere Cognitive Control Architecture and may be serialized in JSON, Protobuf, or equivalent typed data formats.

Policy-Gate Governance. In certain embodiments, the Compliance Interface enforces policy rules at four distinct policy-gate stages: (1) Pre-Compose (validating task inputs and archetype selection), (2) Pre-Execute (authorizing agent instantiation and signature issuance), (3) In-Loop (monitoring active telemetry during operation), and (4) Pre-Emit (validating adaptation and retirement events). These gates correspond to the compliance-evaluation points of the underlying governance framework, ensuring consistency between reasoning control and lifecycle management.

The Loop Governor monitors telemetry statistics to detect non-convergent lifecycle behavior across policy gates. When oscillation or excessive adaptation frequency is observed, the Loop Governor suspends further lifecycle actions and transmits an alert to the Compliance Interface for review.

Loop Governor Algorithm. The Loop Governor 270 implements a stability-control algorithm monitoring adaptation and retirement cycles: Initialize convergence_window=W and threshold=ε. While Lifecycle Manager 140 is active: Capture vector C={adaptation_frequency, mean_conflict_rate, policy_update_count}. Compute Δ=|C(t)−C(t−1)|. If Δ>ε for more than W consecutive cycles: Set state=SUSPEND. Notify Lifecycle Manager 140 and Compliance Interface 150 to halt further adaptations. Record event “non-convergent behavior detected” in Audit Log 154. Wait for manual or automated stabilization signal before resuming. Else continue monitoring. EndWhile.

Implementation Variability and Equivalents. The algorithms described in previous paragraphs are exemplary and may be implemented using deterministic logic, rule-based systems, probabilistic models, or machine-learning techniques. In certain embodiments, the functions of parsing, scoring, and evaluation may be executed by neural-network modules trained on historical agent performance or compliance data, while in others, the same logic may be expressed as explicit decision trees or state machines. Parallel, distributed, or asynchronous implementations of these algorithms are likewise contemplated, including those executed within containerized microservices or federated AI environments. Accordingly, variations in the ordering, weighting, or computational realization of these algorithmic steps are considered functionally equivalent and within the scope of the invention as claimed.

Collectively, these components form a modular architecture in which each element may be scaled or enhanced independently. For example, a more sophisticated Context Compiler based on AI planning algorithms may be substituted without altering other components, and new archetype templates may be introduced without system downtime.

While certain embodiments have been described, the invention may be embodied in other specific forms without departing from its spirit or essential characteristics. The described embodiments are therefore to be considered illustrative and not restrictive, and the scope of the invention is indicated by the appended claims rather than by the foregoing description.

### Operation —Agent Generation and Evolution Process

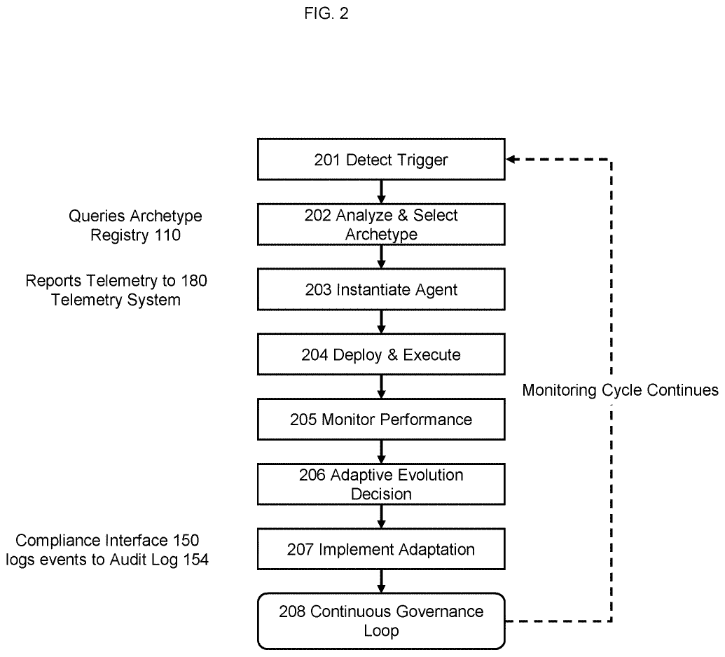

Referring now to FIG. 2, a flowchart 200 illustrates an exemplary process for dynamic agent generation, adaptation, and retirement according to embodiments of the present invention. The ALG Layer operates as an autonomous lifecycle control system for governed AI agents.

(1) Detect Trigger (Step 201). The process begins when a trigger event occurs. Trigger types may include: (a) the arrival of a new goal or task within the AI platform; (b) detection of an underperforming or idle agent based on telemetry metrics; (c) identification of new contextual data or system conditions requiring novel capabilities; or (d) an external compliance update or policy revision. Upon detection, the trigger is transmitted to the Context Compiler 120 for analysis.

(2) Analyze and Select Archetype (Step 202). The Context Compiler interprets the trigger to determine the appropriate archetype or action. For instance, if the trigger corresponds to a new translation task, the compiler identifies the “Translator” archetype from the Archetype Registry 110. If the trigger stems from an underperforming agent, the compiler evaluates whether retraining or replacement is warranted. If no suitable archetype exists, the system generates a placeholder archetype request, prompting human review for future registry expansion. The compiler outputs a reconfiguration plan specifying which agents to create, modify, or retire.

(3) Instantiate Agent (Step 203). If a new agent is required, the Agent Forge 130 retrieves the selected archetype definition and contextual parameters. It performs the following operations: (a) allocates system resources and loads the designated model or rule set; (b) assigns a Lineage ID linking the agent instance to its archetype and, if applicable, to its predecessor; (c) requests a Compliance Signature from the Compliance Interface 150 defining the agent's permissions and restrictions; (d) registers the agent with the Telemetry system 180 for ongoing performance monitoring; and (e) records the creation event in the Audit Log 154 with timestamp, archetype ID, and authorization context. Upon successful initialization, the agent becomes active in the Agent Pool 190.

(4) Deploy and Execute (Step 204). The new agent begins performing its assigned function in coordination with other agents. The overarching orchestrator (e.g., a Dual-Hemisphere MCP or equivalent controller) routes relevant tasks to the new agent. The agent continuously emits telemetry signals—including status updates, output metrics, and policy-compliance confirmations—to the Lifecycle Manager 140 and Compliance Interface 150.

(5) Monitor Performance (Step 205). The Lifecycle Manager observes telemetry data and evaluates agent performance against predefined metrics and system goals. Examples include accuracy, latency, or redundancy indices. The manager also identifies inter-agent conflicts or duplication. If performance and compliance remain within tolerance, the agent continues operation until a new trigger arises.

(6) Adaptive Evolution Decision (Step 206). Upon detecting a lifecycle trigger condition, the Lifecycle Manager determines the appropriate adaptation strategy. Representative actions include: (a) Retuning or Retraining, adjusting parameters or updating models to restore performance; (b) Spawning a Successor, invoking the Agent Forge to instantiate a replacement or complementary agent; (c) Merging or Partitioning, consolidating or dividing agent roles to resolve redundancy; or (d) Compliance Reaction, regenerating agents in response to policy updates requiring new configurations or restrictions. The Lifecycle Manager validates each decision through the Compliance Interface before execution.

(7) Implement Adaptation (Step 207). Once approved, the Lifecycle Manager executes the adaptation plan. This may include initiating retraining cycles, spawning replacement agents, or retiring outdated ones. The Compliance Interface ensures that transitions conform to policy—for example, by requiring data purging before retirement or adjusting Compliance Signatures during merges. All lifecycle events are appended to the Audit Log 154 for traceability.

(8) Continuous Governance Loop. The operation repeats as a self-regulating cycle. The system continuously evaluates agent performance, compliance state, and environmental changes. If excessive or non-convergent adaptation behavior is detected, the Loop Governor 270 temporarily suspends lifecycle actions to prevent recursive oscillations, thereby stabilizing the agent ecosystem.

Over time, the system autonomously evolves a balanced, policy-compliant set of agents optimized for task demands. Each agent's creation, modification, and termination remains fully traceable via lineage and compliance records, enabling post-hoc auditability and regulatory assurance.

### Governance and Unique Features

The ALG Layer incorporates a set of structural and procedural mechanisms that distinguish it from prior multi-agent orchestration frameworks. These mechanisms collectively establish an adaptive yet governed ecosystem in which agent creation, modification, and retirement are transparent, traceable, and policy-compliant.

Schema-Driven Agent Synthesis. Each agent is instantiated from an explicit archetype schema that defines behavioral parameters, interfaces, and compliance constraints. By enforcing archetype inheritance at creation time, the system ensures that all generated agents conform to approved operational and ethical standards. Unlike prior art that allowed ad-hoc or uncontrolled agent spawning, this approach enforces deterministic and auditable instantiation.

Inherited Compliance and Telemetry. Every agent includes embedded governance hooks: (a) a Lineage ID for genealogical traceability; (b) a Compliance Signature encoding permissions, restrictions, and attestation data; and (c) a Telemetry Endpoint linking the agent to continuous monitoring channels. These hooks provide a persistent chain of custody from creation to retirement, enabling real-time oversight and post-hoc forensic analysis.

Lifecycle Automation. Traditional AI maintenance requires human intervention for retraining, redeployment, or version management. In contrast, the ALG Layer automates these activities under supervision of the Lifecycle Manager 140. Trigger-driven adaptation cycles execute automatically yet remain bounded by compliance review, combining efficiency with regulatory control.

Integration with Higher-Level Orchestration. The architecture is compatible with cognitive controllers such as the Dual-Hemisphere MCP or equivalent supervisory systems. In such configurations, the MCP governs reasoning and task sequencing, while the ALG Layer manages population composition—determining which agents exist and when. This dual-layer arrangement provides separation of cognitive reasoning and generative governance, yielding both agility and safety.

Cross-Domain Flexibility. Because archetypes are domain-agnostic, the same governance framework applies across application areas—e.g., procurement analytics, medical diagnostics, logistics optimization, or autonomous control. Organizations may maintain a single ALG Layer deployment to orchestrate multiple departments or product lines, each drawing from its own subset of archetypes while inheriting common policy enforcement from the Compliance Interface 150.

Loop-Governed Stability. Through the Loop Governor 270, the system prevents uncontrolled oscillation in adaptation cycles. When successive agent modifications fail to converge toward stability, the Loop Governor halts lifecycle activity and requires administrative or automated stabilization before resuming. This feature provides a safety mechanism analogous to feedback damping in control systems, ensuring equilibrium within the governed agent population.

Auditability and Trust. All lifecycle events—creation, retraining, merging, and retirement—are immutably logged in the Audit Log 154, complete with timestamps, archetype identifiers, and reason codes. This persistent record supports compliance verification, risk assessment, and root-cause investigation in regulated environments.

Collectively, these features establish ALG Layer as a governed generative framework that unifies adaptability with control. The invention provides technical advantages including continuous policy enforcement, structural traceability, reduced human maintenance overhead, and safe scalability of AI ecosystems.

### Example Scenario

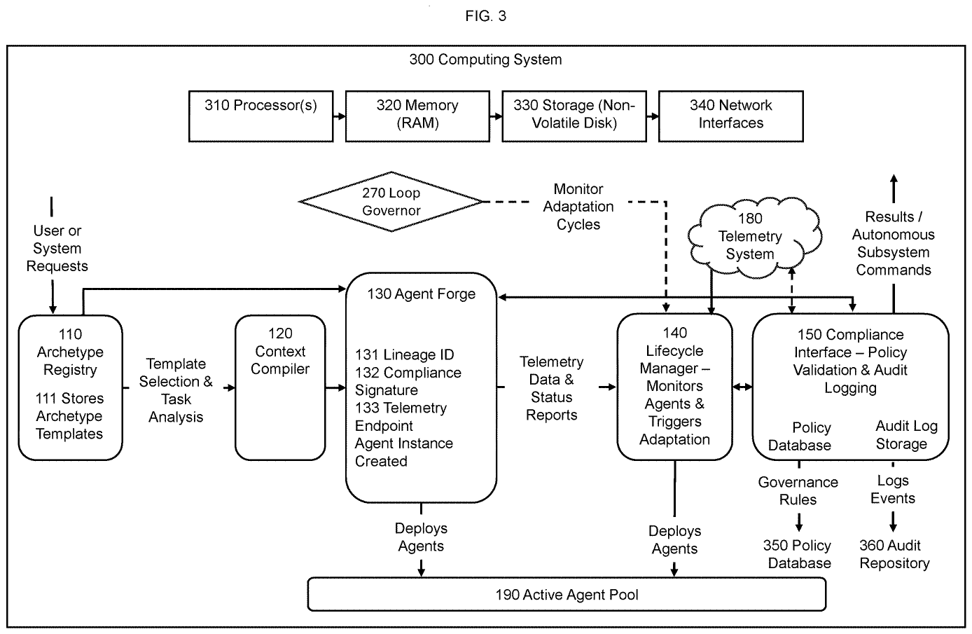

To illustrate operation of the invention, FIG. 2 and FIG. 3 may be considered together in the context of an enterprise-scale deployment. The following example is representative and non-limiting; those skilled in the art will recognize that the same processes apply across varied industries and domains.

Enterprise Customer-Interaction Platform. Consider a corporate customer-service environment that initially deploys two classes of AI agents: (a) an Email-Response Agent archetype for processing customer emails, and (b) a Chat-Assistant Agent archetype for live-chat interactions. Both are instantiated through the Agent Forge 130 and managed under policy rules within the Compliance Interface 150.

Emergent Requirement Detection. Over time, the Context Compiler 120 detects that incoming messages from social-media channels remain unhandled. It classifies this as a new-context trigger under Step 201 and queries the Archetype Registry 110. A previously defined but unused archetype—SocialMediaResponder—is identified as suitable. The Context Compiler transmits an instantiation request to the Agent Forge 130, which launches the new agent with an assigned Lineage ID, Compliance Signature, and Telemetry Endpoint.

Governed Deployment. The SocialMediaResponder agent is deployed into the Active Agent Pool 190 and begins posting approved responses to social-media inquiries. Its Compliance Signature limits operations to pre-authorized corporate accounts and prohibits access to internal data systems. All outgoing messages are logged automatically by the Compliance Interface 150 for auditability.

Policy Update and Adaptive Response. Subsequently, corporate policy changes to require legal pre-review of all public statements containing specified sensitive terms. The Compliance Interface 150 propagates this new rule to the Lifecycle Manager 140. Upon the next rule-synchronization cycle, the Lifecycle Manager triggers the creation of a LegalFilter agent derived from a Compliance-Review Archetype to intercept and validate messages before publication.

Dynamic Agent Coordination. The LegalFilter agent is inserted into the communication workflow between the SocialMediaResponder agent and the outbound message interface. The Context Compiler updates the orchestration plan to reflect this dependency, and the Agent Forge 130 registers telemetry endpoints for both agents to facilitate cross-monitoring. From this point forward, every outbound post is reviewed by the LegalFilter agent, ensuring adherence to the updated compliance rule.

Audit and Stabilization. The Audit Log 154 records each lifecycle event: (a) creation of the SocialMediaResponder agent, (b) issuance of its Compliance Signature, (c) instantiation of the LegalFilter agent in response to a policy update, and (d) verification of successful workflow stabilization by the Loop Governor 270. If further adaptation cycles begin oscillating—for example, repetitive attempts to adjust thresholds—the Loop Governor suspends additional modifications until manual or automated review confirms convergence.

Outcome and Advantages. The governed environment thereby expands its functional scope (new communication channel) without violating compliance or introducing instability. All actions are logged, every agent remains traceable to its archetype, and the adaptation process proceeds automatically yet within the boundaries of enforceable governance. This scenario exemplifies how the invention enables continuous, safe evolution of multi-agent systems in real-world enterprise settings.

### Implementation Considerations

The ALG Layer may be realized through multiple computing architectures, including microservice-based, cloud-native, and on-premises configurations. The following examples describe representative implementations that support scalability, security, and interoperability without limiting the scope of the invention.

Software Microservices Architecture. Each core component—the Archetype Registry 110, Context Compiler 120, Agent Forge 130, Lifecycle Manager 140, Compliance Interface 150, and associated telemetry and audit subsystems—may be implemented as independent microservices communicating through authenticated APIs or message queues. This modularization enables horizontal scaling of high-load components (for example, the Lifecycle Manager 140) without affecting the integrity of governance operations handled by the Compliance Interface 150.

Container Orchestration and Deployment. In a cloud deployment, the Agent Forge 130 can interface with a container orchestration platform (e.g., Kubernetes, OpenShift, or equivalent) to instantiate new agent instances as lightweight containers or pods. Each container executes the runtime corresponding to its archetype definition and is injected at launch with its unique Lineage ID, Compliance Signature, and Telemetry Endpoint parameters. Container lifecycle hooks integrate directly with the Lifecycle Manager 140 for start, pause, and retirement signals.

Integration with Model Registries and MLOps Pipelines. Archetypes that define machine-learning agents reference specific model artifacts or rule sets stored in a model registry. When a new agent is instantiated, the Agent Forge 130 retrieves the designated artifact version, ensuring reproducibility and traceable lineage of model evolution. This linkage complements conventional MLOps tooling by extending governance beyond model training to encompass full operational lifecycle management.

Security and Access Control. The Compliance Interface 150 enforces runtime security constraints in coordination with an underlying access-control system. Each Compliance Signature may be mapped to infrastructure-level roles or tokens defining permitted actions (for example, file read/write privileges, API access, or data-zone visibility). Attempts by any agent to exceed its authorized scope result in automatic interception and logging of a non-compliance event. Optionally, the system may integrate with an enterprise identity provider to ensure end-to-end authentication of all agent interactions.

Performance and Scalability. For large deployments comprising hundreds or thousands of active agents, performance optimization is achieved through asynchronous telemetry batching and distributed evaluation of lifecycle triggers. The Lifecycle Manager 140 may schedule periodic review intervals or apply adaptive thresholds to prevent thrashing (excessive spawning and retirement cycles). The Loop Governor 270 provides an additional safeguard by detecting non-convergent adaptation patterns and suspending activity until equilibrium metrics return within nominal ranges.

Collaboration with Cognitive Orchestrators. In advanced embodiments, the ALG Layer operates beneath a higher-order controller such as a Dual-Hemisphere MCP, responsible for real-time reasoning and decision sequencing. The MCP identifies what reasoning must occur, while the ALG Layer determines who (which agents) should perform it. Coordination between these tiers ensures both cognitive agility and structural compliance, forming a complete governed intelligence stack.

Interoperability and Extensibility. Because each component communicates through standardized interfaces, the system can integrate with third-party analytics tools, enterprise data warehouses, or external policy engines. New archetype types, telemetry schemas, or compliance modules can be added without re-engineering the foundational architecture, ensuring forward compatibility as regulations, models, and business domains evolve.

Operational Resilience and Failover. To ensure high availability, each core service may be deployed in redundant clusters. The Audit Log 154 and Policy Store 152 may use fault-tolerant distributed databases with transaction-level replication. In the event of component failure, agents persist their compliance and lineage data to enable reconstruction of full state upon recovery, thereby preserving governance continuity.

Through these implementation patterns, the ALG Layer can be realized within heterogeneous enterprise environments while preserving the fundamental characteristics of adaptive generation, traceable lifecycle control, and embedded compliance.

### Distinction From Prior Art

The ALG Layer architecture materially diverges from existing multi-agent and orchestration systems through its integrated schema-driven governance and autonomous lifecycle control. The following distinctions are presented for clarity and do not limit the invention except as defined by the appended claims.

Dynamic Lifecycle Management vs. Static Pipelines. Prior orchestration frameworks such as LangChain (2023) or Semantic Kernel (2023) require manual definition of fixed agent chains. They lack the capacity to generate, retire, or merge agents automatically during execution. The present invention introduces the Lifecycle Manager 140 and Agent Forge 130, which cooperatively perform real-time agent creation and retirement governed by policy rules—transforming agent management from a static configuration into a controlled, adaptive process.

Embedded Governance vs. External Checks. Conventional systems rely on ad-hoc developer-implemented safeguards. By contrast, the ALG Layer embeds compliance metadata directly within each agent at instantiation. The Compliance Interface 150 applies enforcement through the agent's Compliance Signature, ensuring every operational event (creation, modification, or retirement) is intrinsically tied to a policy-verifiable record rather than to external audit scripts or runtime heuristics.

Template-Inheritance Framework. Existing agent ecosystems, including AutoGPT (2023) and AutoGen (2024), allow free-form agent spawning without standardized structure or compliance inheritance. ALG Layer defines all agents through archetype templates in the Archetype Registry 110, each carrying versioned schemas and compliance constraints. This inheritance model guarantees that new agents conform to the latest approved archetype revision, eliminating uncontrolled proliferation.

Loop-Governed Stability Mechanism. No prior art describes a feedback-control element for halting recursive adaptation in multi-agent governance. The disclosed Loop Governor 270 provides this technical safeguard by detecting non-convergent adaptation patterns and suspending lifecycle operations until stability is achieved, preventing runaway self-modification cycles.

Holistic Lifecycle as a First-Class Process. Conventional systems orchestrate task execution but not the lifecycle of the agents themselves. ALG Layer formalizes agent birth, adaptation, and retirement as managed system events with dedicated audit tracking in the Audit Log 154. This design parallels operating-system-level process management while introducing compliance context unavailable in prior frameworks.

Governed Generativity and Cross-Domain Applicability. Where prior frameworks focus on conversational or task-specific coordination, ALG Layer enables governed generativity across domains—from enterprise procurement to scientific simulation—without modification of its control logic. Compliance enforcement and lineage tracking remain consistent regardless of application, yielding a universally governed generative substrate for AI ecosystems.

### Integration with Cognitive Controllers

Prior systems treat orchestration and reasoning as inseparable. The disclosed architecture decouples them, allowing coordination with higher-order controllers such as a Dual-Hemisphere MCP. This separation enables reasoning intelligence to evolve task strategies while the ALG Layer manages population composition under strict governance boundaries.

Auditable Lineage and Policy Propagation. Existing frameworks lack immutable provenance for agent evolution. ALG Layer enforces audit continuity by linking each agent's Lineage ID, archetype reference, and Compliance Signature throughout its lifecycle. Updates to archetype compliance schemas propagate automatically to new agents, ensuring continuous alignment with evolving policy or regulation.

Through these structural and functional distinctions, ALG Layer establishes a novel class of governed agent-generation architecture, offering the combined advantages of dynamic adaptability, policy-embedded oversight, stability control, and verifiable lineage—capabilities absent from existing multi-agent or orchestration systems.

The foregoing description illustrates representative embodiments of the ALG Layer system and method for schema-driven AI-agent generation and lifecycle governance. The invention introduces a unified technical framework for defining, instantiating, monitoring, and retiring AI agents under continuous compliance control. By embedding governance metadata, lineage tracking, and adaptive lifecycle management into the generative substrate itself, the invention enables intelligent systems to evolve autonomously while remaining auditable and policy-conformant.

Distinct from prior art, the disclosed architecture formalizes governed generativity—the capacity of an AI ecosystem to self-expand or self-modify in response to contextual change while remaining bounded by explicit compliance schemas. Through the integration of the Archetype Registry 110, Context Compiler 120, Agent Forge 130, Lifecycle Manager 140, Compliance Interface 150, and the Loop Governor 270, the invention achieves a controlled equilibrium between adaptability and regulatory assurance.

The described embodiments collectively demonstrate how the ALG Layer transforms static orchestration pipelines into an adaptive, self-regulating environment. Each agent generated by the system carries an immutable lineage identifier and a verifiable compliance signature, ensuring traceability throughout its operational life. The system's policy-enforcement fabric and feedback stabilization via the Loop Governor provide the technical means to prevent recursive instability while maintaining continuous operational integrity.

The invention may be implemented in various configurations—including cloud, on-premises, and hybrid infrastructures—without departing from its fundamental principles of schema-based control, governed adaptation, and persistent auditability. The modular design further allows interoperability with existing orchestration or reasoning frameworks, such as a Dual-Hemisphere MCP, to form a complete cognitive-governance stack.

While certain embodiments have been described, the invention may be embodied in other specific forms without departing from its spirit or essential characteristics. The described embodiments are therefore to be considered in all respects as illustrative and not restrictive, and the scope of the invention is indicated by the appended claims rather than by the foregoing description. All variations that come within the meaning and range of equivalency of the claims are to be embraced within their scope.

The algorithmic processes disclosed herein are not limited to any particular programming language, software architecture, or computing platform. Equivalent implementations using different computational logic, flow control, or data representations are within the scope of the invention, provided that they perform substantially the same functions of governed agent generation, lifecycle management, and compliance enforcement as described.

What is claimed is:

1. A system for dynamic generation and governance of artificial-intelligence agents, the system comprising:
(a) an archetype registry storing a plurality of agent templates, each agent template defining a type of AI agent with associated capabilities and compliance constraints;
(b) a context compiler configured to receive task information or system-context data and to select, based on the task information, at least one agent template from the archetype registry that is suitable for addressing a given task or context;
(c) an agent forge coupled to the archetype registry and the context compiler, the agent forge being configured to instantiate a new AI-agent instance from the selected agent template, including assigning a unique lineage identifier to the agent instance and embedding a compliance-metadata profile into the agent instance;
(d) a lifecycle manager coupled to a telemetry system monitoring active AI agents, the lifecycle manager being configured to evaluate performance metrics and trigger conditions associated with the active AI agents and, in response to detecting a trigger condition, to initiate a lifecycle action selected from adapting an AI agent's parameters, spawning an additional AI agent, merging responsibilities of multiple AI agents, or retiring an AI agent; and
(e) a compliance interface connected to a policy store of governance rules, the compliance interface being configured to (i) determine compliance requirements for each new AI-agent instance instantiated by the agent forge and issue the compliance-metadata profile comprising those requirements and (ii) enforce the governance rules during operation of the active AI agents by intercepting non-compliant actions and logging lifecycle events;
wherein the system operates such that AI-agent instances are dynamically generated, modified, and terminated in accordance with predefined templates and governance rules, thereby ensuring that all AI-agent instances inherit policy constraints and are tracked via lineage throughout their lifecycle.

2. The system of claim 1, wherein each agent template in the archetype registry includes a version indicator and is updatable, and wherein any subsequently instantiated AI-agent instances automatically use the most recent approved version of the agent template.

3. The system of claim 1, wherein the compliance-metadata profile assigned to each AI-agent instance comprises (i) a compliance signature attesting that the agent instance was created in accordance with approved policies, and (ii) a set of permissions and restrictions defining allowed resources or actions, and wherein the compliance interface prevents the AI-agent instance from exceeding the defined permissions during runtime.

4. The system of claim 1, wherein the context compiler is further configured to detect when no existing agent template sufficiently matches a novel task requirement and, in response, to generate a notification or placeholder template indicating a need for a new archetype entry, thereby facilitating expansion of the archetype registry.

5. The system of claim 1, wherein the agent forge instantiates the new AI-agent instance by launching a software process or thread that implements functionality defined by the selected agent template and registers the AI-agent instance with a telemetry endpoint for real-time monitoring by the lifecycle manager and compliance interface.

6. The system of claim 1, wherein the lifecycle manager evaluates telemetry data against a set of predefined trigger conditions comprising: (i) an under-performance trigger satisfied when an AI agent's performance metric falls below a threshold, (ii) a new-context trigger satisfied when an unhandled task type or input is detected, (iii) a peer-conflict trigger satisfied when multiple AI agents produce conflicting or redundant outputs, and (iv) a compliance-update trigger satisfied when a governance rule in the policy store changes, and wherein the lifecycle manager initiates corresponding lifecycle actions in response to said triggers.

7. The system of claim 6, wherein in response to the peer-conflict trigger, the lifecycle manager generates a merge plan retiring the conflicting agents and invoking the agent forge to instantiate a consolidated AI-agent instance that inherits lineage links to the retired agents.

8. The system of claim 1, wherein the compliance interface logs each agent-lifecycle event in an audit log, the events comprising at least agent-creation, adaptation, and retirement, each entry including lineage identifiers, template identifiers, and reason codes, thereby producing an auditable record of the agent population over time.

9. The system of claim 1, wherein each AI-agent instance operates within a secure execution sandbox configured by the compliance interface according to the agent's compliance-metadata profile, such that attempts to access disallowed resources or perform disallowed operations are automatically blocked and logged.

10. The system of claim 1, wherein the archetype registry contains agent templates for multiple task domains, and the context compiler is configured to select multiple agent templates for a composite task, the agent forge instantiating a plurality of cooperating AI-agent instances and the lifecycle manager optimizing said collaboration over time.

11. The system of claim 1, further comprising a loop governor configured to monitor adaptation cycles of the lifecycle manager and to suspend lifecycle reconfiguration upon detecting non-convergent behavior.

12. The system of claim 1, wherein each AI-agent instance transmits telemetry data encapsulated in typed telemetry objects comprising at least a confidence value, reasoning-class identifier, constraint code, and provenance hash, the lifecycle manager and compliance interface using said telemetry data for convergence assessment and governance auditing.

13. The system of claim 1, wherein compliance enforcement occurs at four policy-gate stages comprising pre-compose, pre-execute, in-loop, and pre-emit, each gate enforcing a corresponding subset of governance rules to validate agent creation, operation, adaptation, and retirement.

14. The system of claim 1, wherein the archetype registry, context compiler, agent forge, lifecycle manager, and compliance interface are implemented as distinct services within a cloud-computing environment, and wherein an orchestration layer coordinates communication among said services to enable real-time agent-lifecycle adjustments.

15. The system of claim 1, wherein the context compiler and lifecycle manager extend an existing AI-model orchestration framework by intercepting unhandled task types to spawn new agents and by providing feedback to route tasks to the current optimal set of agents, thereby enhancing the framework with adaptive agent-generation and retirement capabilities.

16. The system of claim 1, wherein the context compiler, agent forge, lifecycle manager, compliance interface, and loop governor execute respective algorithms comprising the steps described in paragraphs [0039] through [0050] of this specification.

17. A computer-implemented method for dynamically managing the lifecycle of AI agents with embedded compliance, the method comprising:
receiving a trigger event indicating one of (a) a new task to be handled, (b) a performance anomaly of an existing AI agent, (c) a change in context or data availability, or (d) a policy update;
consulting an archetype registry storing definitions of AI-agent types to determine at least one archetype relevant to the trigger event;
instantiating a new AI agent based on the determined archetype by launching an AI process configured according to the archetype, assigning a unique lineage identifier, and associating a compliance signature defining permitted operations;
integrating the new AI agent into operation by establishing a telemetry connection and updating a registry of active agents;
monitoring, via a lifecycle-management module, performance and behavior of active AI agents through the telemetry connection;
upon detecting a lifecycle trigger condition, executing a lifecycle action selected from:
adjusting configuration, spawning an additional AI agent, merging two or more AI agents, or retiring an AI agent; and
enforcing, via a compliance module, policy constraints by intercepting disallowed actions and logging each instantiation and retirement event with corresponding lineage and compliance information,
whereby the method enables an AI system to evolve its set of agents dynamically while maintaining compliance with predefined governance rules.

18. The method of claim 17, wherein instantiating the new AI agent includes retrieving a specific version of a model or rule set defined by the archetype and loading said version into the agent's runtime environment to ensure conformance with archetype specifications.

19. The method of claim 17, further comprising, prior to instantiation, verifying that the requested AI-agent creation is permitted under current policy, and if not, initiating a compliance-approval workflow or modifying the request according to governance rules before proceeding.

20. The method of claim 17, wherein the lifecycle trigger condition includes detection that an AI agent has been idle or unused beyond a threshold period, and wherein the lifecycle action comprises gracefully retiring that AI agent by ceasing task acceptance, updating registry status, and revoking its compliance signature.

21. The method of claim 17, wherein merging multiple AI agents includes transferring persistent state or learned knowledge into a newly instantiated successor agent and updating lineage records to indicate that the successor inherits from the merged agents.

22. The method of claim 17, wherein detecting a policy violation by an active AI agent automatically triggers the lifecycle-management module to replace the agent with a new instance configured according to an updated archetype that complies with the revised policy, thereby self-correcting compliance.

23. The method of claim 17, wherein all instantiation, adaptation, merging, and retirement operations are recorded in a machine-readable audit log including timestamps, agent identifiers, archetype references, and actions taken, enabling post-hoc review of the AI system's evolution.

24. A non-transitory computer-readable storage medium storing instructions that, when executed by one or more processors, cause the one or more processors to perform the method of any of claims 17 through 23 for dynamically managing the lifecycle of AI agents with embedded compliance.
